(19) United States
(12) Patent Application Publication
(10) Pub. No.: US 2014/0158636 A1
(43) Pub. Date: Jun. 12, 2014

(54) Portable External Modular Filtering and Contamination Removal System and Method of Use

(71) Applicant: Sky Bleu Martin, Seattle, WA (US)

(72) Inventor: Sky Bleu Martin, Seattle, WA (US)

(21) Appl. No.: 14/183,189

(22) Filed: Feb. 18, 2014

Related U.S. Application Data
(62) Division of application No. 13/041,359, filed on Mar. 5, 2011.

(51) Int. Cl. B63J 4/00; C02F 1/00; B01D 35/05

(52) U.S. Cl. CPC B63J 4/002; B01D 35/05; C02F 1/001
USPC 210/747.6

(57) ABSTRACT

A method of using a portable external modular filtering system is disclosed where each layer of filtering assembly is assembled by attaching the appropriate multi-side vertical frame to a horizontal platform and attaching an appropriate filter material leaving slack for the filter material to create a temporary filter pool. Macro-particle, micro-particle or nano-particle filtration is accomplished using multiple filters and layers. An optional horizontal top layer may serve as a shock absorber to dissipate the force of the discharge and to collect large pieces of debris. Additional serial units are used depending on the speed of filtering desired. After the discharge is finished exiting the ship and is filtered, the filter material and the contaminants can be rolled up and put into plastic bags to be reported, tested, studied and/or destroyed as appropriate for the type and level of contaminant and the local regulations.

### CROSS-REFERENCE TO RELATED APPLICATIONS

This application is a divisional application of copending U.S. patent application Ser. No. 13/041,359 filed Mar. 5, 2011. This application claims priority to U.S. Provisional patent application No. 61/319,895 entitled “External Modular Filtering and Contamination Removal System and Method of Use” filed on Apr. 1, 2010, which provisional application is incorporated herein by reference in its entirety; this application claims the benefit of the provisional's filing date under 35 U.S.C.119(e). The present invention is related to the following commonly-invented and co-pending U.S. patent application Ser. Nos. 12/615,960 filed on Nov. 10, 2009 and 12/137,182 filed Jun. 11, 2008 and 13/007,767 filed Jan. 17, 2011 (which is a continuation-in-part of 12/137,182) which are incorporated by reference in their entirety.

### STATEMENT REGARDING FEDERALLY SPONSORED RESEARCH OR DEVELOPMENT

Not applicable

### REFERENCE TO SEQUENCE LISTING, A TABLE, OR A COMPUTER PROGRAM LISTING COMPACT DISC APPENDIX

Not applicable

### BACKGROUND OF THE INVENTION

This application relates to a portable external modular filtering system and method of use for ship-side liquid separation of invasive species, contaminants, hydrocarbons and other macro-, micro- or nano-particles from discharge. The modular filtering system may be off-loaded from the ballast water containing vessel (vessel-based) or off-loaded from shore, a pier, ship or other port-based source or used for emergency or nonemergency ballast water filtering.

The prior art contains many different types of treatment systems that are fixed both in location and fixed in configuration. The fixed locations for the prior art are on the vessel (capital equipment treatment systems that are either built in originally or retrofitted), fixed on a service vessel or fixed on land. The costs of these fixed systems are inherently high because of the need for large treatment systems of the contaminated discharges and the cost of storing contaminated discharge at various stages of the processing.

The prior art treatment systems are also of unknown and varying effectiveness for killing or neutralizing every type of invasive species, contaminants, hydrocarbon and other macro-, micro- or nano-particles. Each treatment system has its own way of killing or neutralizing contaminants but many being used may be putting a new breed of contaminants into the water themselves in the form of the treated water changing the harm (resistant species and chemically treated discharge) rather than removing it.

### BRIEF SUMMARY OF THE INVENTION

The invention is a portable external modular filtering and contamination removal system for a ship (Enviro Catch®, a registered trademark of Skyler Enterprises). The invention comprises a plurality of non-fixed position modular filter assemblies to filter and remove macro-, micro- and nano-particle contaminates ship-side. The filter assemblies may be vessel-based or port based. A floating access and maintenance unit provides easy access to the filter assemblies. The filter assemblies move in cooperation with each other to spread the contaminated discharge over multiple units. A flow collecting and diverting apparatus seals against the ship to prevent contaminated discharge from running down the side of the ship with a directional discharge to divert contaminated discharge to waiting filter assemblies.

### BRIEF DESCRIPTION OF THE SEVERAL VIEWS OF THE DRAWING

FIG. 1 shows three stacks of non-fixed position modular filter assemblies floating next to a ship. A flow collecting and diverting apparatus is shown that seals to the ship and diverts contaminated discharge away from the ship into the non-fixed position modular filter assemblies.

FIG. 2 shows two stacks of non-fixed position modular filter assemblies placed on a floating access and maintenance unit. A flow collecting and diverting apparatus diverts contaminated discharge away from the ship into the non-fixed position modular filter assemblies.

FIG. 3 shows a flow collecting and diverting apparatus that can be maneuvered to divert contaminated discharge in a number of directions away from the ship and into the non-fixed position modular filter assemblies.

FIG. 4 shows discharge coming from a ship port and a flow collecting and diverting apparatus collecting dripping discharge flow and diverting the water into the external modular filtering system.

### DETAILED DESCRIPTION OF THE INVENTION

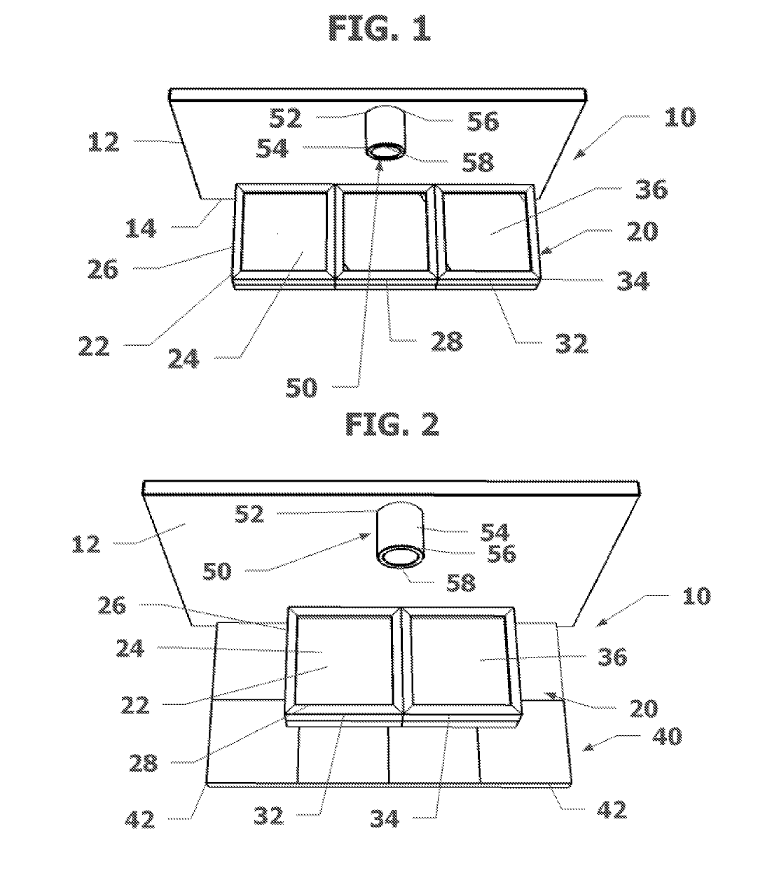

Referring now to the drawings, FIG. 1-4 wherein like reference numerals designate like elements.

A portable external modular filtering system 10 comprises a plurality of non-fixed position filter assemblies (“filter assembly” or “filter assemblies”) 20 and a floating access and maintenance unit (“floating unit”) 40 in order to filter and remove contaminants from ballast water discharge or other discharges (“discharge”). A flow diverting and collection apparatus (“apparatus”) 50 is used on the ship above the external modular filtering assembly 10 as needed.

A plurality of filter assemblies 20 may be used singly or stacked atop one another and/or connected adjacent (in series) to each other in various configurations for multiple filtering benefits (different stages of filtering). Multiple filtering benefits include multiple levels of filtering (macro-, micro- and nano-particles), higher speeds of contamination removal and lower costs of contamination removal.

The filter assemblies 20 comprise a vertical support frame 34; a horizontal platform 32 with a plurality of sides that corresponds to the vertical support frame 34; a section of filter material 22 with a plurality of sides that corresponds to the vertical support frame with the appropriate mesh size 24; filter material sides 26; and easy release mechanical connections 28.

One or more sections of filter material 22 with one or more appropriate mesh sizes 24 remove contaminants from discharge from sources such as ballast water or bilge water from a port of a ship or an applicable discharge from another source. The filter assembly 20 removes a plurality of contaminants including evasive aquatic nonindigenous species such as Fish, Zebra and Quagga Mussels, Asiatic Clam, Aquatic Weeds, Green Crabs, or microbes or other suspended particle contaminants, while allowing a plurality of water and oil to permeate the filter assembly 20.

A plurality of section filter material sides 26 serve to allow mechanical connection to secure the filter material 22 to a plurality of shapes of vertical support frames 34 with a plurality of easy release mechanical connections 28 to provide joining to a plurality of vertical support frames 34 and providing easy removal so the filter material 22 can be removed and destroyed or stored. Stored contaminants may be packaged and provided to local or state authorities to demonstrate compliance with environmental standards where applicable and to provide material for studying what contaminates are coming from where and how they can be destroyed or avoided.

The vertical support frame 34 may be of any shape and be made of materials such as wood, metal, plastic, Enviro Boom® (registered trademark of Skyler Enterprises), inflatable booms or other appropriate materials and where the frame height is sufficient to create a temporary filtering pool of discharge inside the frame in mechanical cooperation with a plurality of horizontal platforms 32 of corresponding shape to the vertical support frame that is mechanically attached to the vertical support frame. The horizontal platforms 32 contain at least one hole for filtered water and oil to exit the non-fixed position filter assembly 20. The platform provides support to the filter material 22 so that the head pressure of the contaminated fluid is distributed over a substantial area of the filter material 22 to allow for fast filtering and to provide vertical support to the filter material 22 and discharge during filtering. The number and size of the holes is balanced between the need for vertical support and the corresponding expected flow rate out of the temporary filtering pool. A plurality of easy release mechanical connections fasten the filter material 22 to the vertical support frames. The horizontal platform 32 may also be used as a top layer to catch large pieces of debris and to break the force of the discharge as it reaches the external filter assembly 20.

A floating access and maintenance unit 40 assembly comprises a plurality of floating modular dock sections (zero or more) that are configured together to allow for access to and maintenance of the plurality of non-fixed position filter assemblies 20. If the number of floating modular dock sections is zero, a small boat (not shown) may be used for the floating access and maintenance unit 40.

A flow diverting and collection apparatus 50 for use with the external modular filtering system 10 comprises a sealing edge 52 to mechanically connect with the side of the ship 12 to divert discharge 18 from exiting the port 16 of the ship 12 and running down the side of the ship 12; a diverting mechanism 54 diverts discharge in one or more alternating directions away from the ship 12 into the external modular filtering system 10; a collection mechanism 56 temporarily holds a volume of discharge before it exits to the external modular filtering system 10 and an orifice 58 discharges the discharge or other discharge. A release mechanism may release the flow from the collection mechanism. A surrounding net or waterproof shield may be employed in conjunction with the apparatus 50 to prevent splashing discharge from contaminating ambient water. The apparatus 50 may have the sealing edge 52 held in place at the side of the ship 12 with magnets.

Because of the modularity of the system, a large number of different configurations and embodiments result. The best mode contemplated at the time of application is contained in one of the following embodiments:

Referring now to FIG. 1, One embodiment is where the external modular filtering system 10 has non-fixed position filter assemblies 20 that are buoyant and float in the ambient water. In this embodiment the filter assemblies 20 may be moved in various configurations to spread out the discharge amongst several non-fixed position filter assemblies 20 in succession so that the total discharge filtering volume is spread out and the total filtering time and filtering cost is kept at a minimum. In this embodiment, most or all of the buoyancy is provided by the filter assemblies 20 and the system is sized to the level of vessel discharge or the time constrictions for removing the contaminants from the vessels applicable discharges.

Now referring to FIG. 2, another embodiment is where the filter assemblies 20 are placed on the floating access and maintenance unit 40 where the floating unit 40 is secured to the ship and the filter assemblies 20 move on the unit 40 or within the floating unit 40 using an automatic or manual propulsion system such as a turntable. This embodiment shifts the variable buoyancy to the floating dock provider who may be port-based and have access to a wide variety of configurations of filter assemblies 20 and a wide variety of modular floating docks or small boats.

Another embodiment is of the filtering system is where filter assemblies 20 are placed on the floating access and maintenance unit 40 where the floating unit 40 moves horizontally along the side of the ship using an automatic or manual propulsion system.

Another embodiment of the filtering system may also employ hydrocarbon absorbing materials in the areas where water exits from the filtering system to absorb oil and other hydrocarbons that may be present in the discharge. Another embodiment may also employ water sampling devices to collect samples of water at applicable stages of the water filtration.

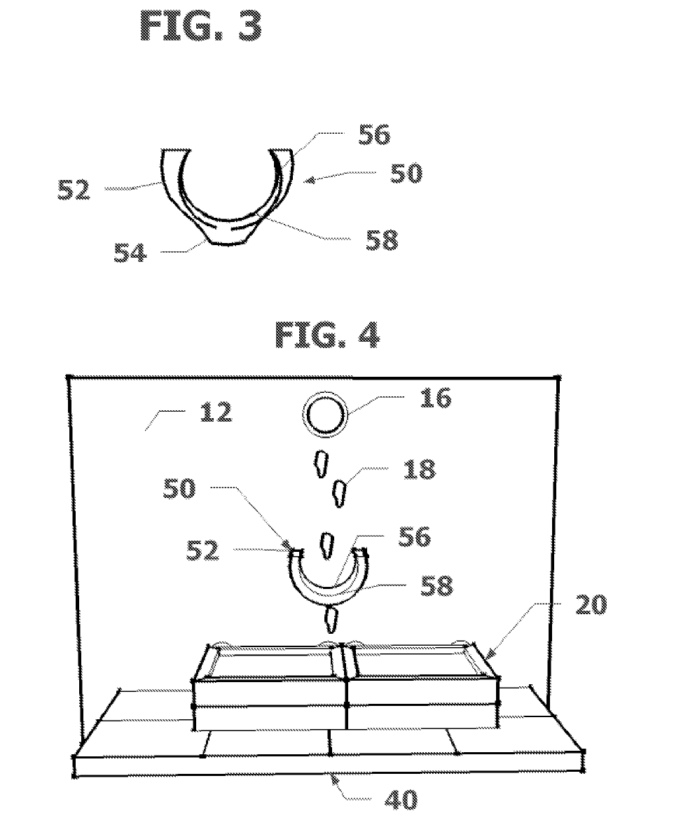

Now referring to FIG. 3 and FIG. 4, a flow diverting and collection apparatus 50 for use with the external modular filtering system 10 comprises a sealing edge 52 to mechanically connect with the side of the ship 12 to divert discharge 18 (FIG. 4) from exiting the port 16 of the ship 12 and running down the side of the ship 12 during discharge; a diverting mechanism 54 diverts discharge in one or more alternating directions away from the ship 12 into the external modular filtering system 10; a collection mechanism 56 temporarily holds a volume of discharge before it exits to the filtering assemblies 20 through an orifice 58. A release mechanism may release the flow from the collection mechanism. The flow diverting and collection apparatus 50 may have the sealing edge 52 held in place at the side of the ship 12 with magnets.

A method of using the external modular filtering system 10 comprises the steps of:

A decision is made on whether to have the filtering assembly 20 provide its own buoyancy or have the buoyancy provided by the floating access and monitoring units 40; this decision is made depending on the availability of floating units 40 and the availability of buoyant vertical support frames 34; if the buoyancy is to be provided by the filtering assembly 20, buoyant vertical frames 34 are used, otherwise other materials may be used; the phrase ‘buoyant vertical frame’ 34 should be assumed below where applicable;

Each layer of filtering assembly 20 is assembled by attaching the appropriate multi-side vertical frame 34 to the corresponding horizontal platform 32 with mechanical connectors and attaching the appropriate filter material 22 using mechanical connectors 28 on the top leaving enough slack so that the filter material 22 can accommodate a temporary filter pool 36;

Additional layers (vertical frame 34, horizontal platform 32, multiple filter materials 22, mechanical connectors 28) are used depending on the level of filtering desired (macro-particle, micro-particle or nano-particle);

An additional horizontal platform 32 may be added on top of the top layer to serve as a shock absorber to dissipate the force of the discharge and to collect large pieces of debris;

Additional serial units are used depending on the speed of filtering desired;

The portable external filtering system 10 is placed below the exit port 16 of the ship 12;

A flow diverting and collection apparatus 50 is placed below the exit port 16 of the ship 12 at a level high enough to divert the discharge appropriately; a surrounding net or waterproof shield may be employed in conjunction with the flow diverting and collection apparatus to prevent splashing discharge from contaminating ambient water;

The filtering assemblies 20 and/or floating access and maintenance unit 40 can be secured to the ship during operation using magnets or other means or may be moved as appropriate during discharge to keep the load spread out to speed up the process; moving may be accomplished manually or automatically;

Discharge is commenced with visual monitoring and visual and audio communication used to communicate between the crew controlling the discharge and the crew for the floating access and maintenance unit 40 where feedback between the crews can result in decreasing, increasing or ceasing discharge as required and changing filter material 22 when and where required;

After the discharge is finished discharging and filtering, the filter material 22 and the contaminants can be rolled up and put into plastic bags to be reported, tested, studied and/or destroyed as appropriate for the type and level of contaminant and the local regulations.

The above disclosure is sufficient to enable one of ordinary skill in the art to practice the invention, and provides the best mode of practicing the invention presently contemplated by the inventor. While there is provided herein a full and complete disclosure of the preferred embodiments of this invention, it is not desired to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like.

What is claimed is:

1. A method use of the portable external modular filtering system comprising the following steps:
A decision on whether to have a plurality of non-fixed position filtering assemblies (“filtering assemblies”) provide their own buoyancy or have the buoyancy provided by a floating access and monitoring units (“floating units”); this decision is made depending on the availability of the floating units and the availability of a plurality of buoyant vertical support frames; if the buoyancy is to be provided by the filtering assemblies, buoyant vertical frames are used, otherwise other materials may be used;
Each layer of filtering assembly is assembled by attaching the appropriate multi-side vertical frame to a corresponding horizontal platform and attaching an appropriate filter material using a plurality of mechanical connectors on the top leaving enough slack so that the filter material can accommodate a temporary filter pool;
Additional layers (vertical frame, horizontal platform, multiple filter materials, mechanical connectors) are used depending on the level of filtering desired (macro-particle, micro-particle or nano-particle);
An additional horizontal platform may be added on top of the top layer to serve as a shock absorber to dissipate the force of the discharge and to collect large pieces of debris;
Additional serial units are used depending on the speed of filtering desired;
The external filtering system is placed below an exit port of a ship;
A flow diverting and collection apparatus is placed below the exit port of the ship at a level high enough to divert the discharge appropriately; a surrounding net or a waterproof shield may be employed in conjunction with the flow diverting and collection apparatus to prevent splashing discharge from contaminating ambient water;
The filtering assembly and/or floating access and maintenance unit can be secured to the ship using magnets or other means or may be moved as appropriate during ballast discharge to keep the load spread out to speed up the process; moving may be accomplished manually or automatically;
Discharge is commenced with visual monitoring and visual and audio communication used to communicate between the crew controlling the ballast discharge and the crew for the floating access and maintenance unit where feedback between the crews can result in decreasing, increasing or ceasing discharge as required and changing filter material when and where required;
After the discharge is finished exiting the ship and is filtered, the filter material and the contaminants can be rolled up and put into plastic bags to be reported, tested, studied and/or destroyed as appropriate for the type and level of contaminant and the local regulations.
